(19) United States
(12) Patent Application Publication
(10) Pub. No.: US 2008/0109880 A1
(43) Pub. Date: May 8, 2008

(54) Wireless local area network system and related method, station, and access point

(75) Inventors: Duan-Ruei Shiu, Taipei City (TW); Chia-Hui Han, Taipei City (TW); Hung-Hsiang Chou, Taipei City (TW); Li-Pin Yeh, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/979,451

(22) Filed: Nov. 2, 2007

(30) Foreign Application Priority Data
Nov. 3, 2006 (TW) 095140675

(51) Int. Cl. H04L 9/00

(52) U.S. Cl. 726/3

(57) ABSTRACT

A method utilized in a wireless local area network (WLAN) system. The WLAN system includes a station and an access point (AP). The method includes steps of: transmitting an input value to the station by the AP; utilizing the input value to calculate an initial service set identifier (SSID) and an initial key by the station; and utilizing the initial SSID and the initial key to perform an authentication procedure by the station and the AP.

### BACKGROUND OF THE INVENTION

1. Field of the Invention

The present invention relates to a wireless local area network (WLAN), and more particularly, to a WLAN setting method bringing users sufficient convenience without sacrificing security.

2. Description of the Prior Art

In recent years, wireless local area network (WLAN) related technology has been developed rapidly in both business and personal applications. Although a WLAN can provide network users with excellent convenience and mobility, it still has the drawback that network users have to execute a complicated WLAN setting process to build wireless association between a WLAN station utilized by the users and a WLAN access point (AP) before the users can benefit from the advantages of the WLAN. It would be a considerable troublesome burden for those users with no professional WLAN knowledge to execute the WLAN setting process.

In the prior art, there are several WLAN setting processes for the users to build wireless association between a WLAN station and a WLAN AP. Some conventional processes have a low security level, and thus those unauthorized users may easily intrude into the WLANs built by those processes. Besides, although some conventional processes have advantages of simple steps, they require participation of the users. Specifically, the users may be required to, for example, press a specific button at a specific time, notice whether a specific indication light flashes, or input a burdensome password during some processes of the prior art. Those requirements surely bring the WLAN users additional troubles and burdens. Therefore, it is desirable to provide a WLAN setting method bringing users sufficient convenience without sacrificing security.

### SUMMARY OF THE INVENTION

The present invention discloses a method utilized in a wireless local area network (WLAN) system, wherein the WLAN system comprises a station and an access point (AP). The method comprises steps of: transmitting an input value to the station by the AP; utilizing the input value to calculate an initial service set identifier (SSID) and an initial key by the station; and utilizing the initial SSID and the initial key to perform an authentication procedure by the station and the AP.

The present invention also discloses a WLAN system, comprising: an AP, for providing an input value; and a station, for receiving the input value provided from the AP and utilizing the input value to calculate an initial SSID and an initial key; wherein the station and the AP utilize the initial SSID and the initial key to perform an authentication procedure.

The present invention further discloses an AP disposed in a WLAN system, wherein the WLAN system further comprises a station. The AP provides the station with an input value and utilizes an initial SSID and an initial key to perform an authentication procedure with the station, and the input value is utilized to calculate the initial SSID and the initial key.

The present invention further discloses a station disposed in a WLAN system, wherein the WLAN system further comprises an AP. The station receives an input value provided from the AP, utilizes the input value to calculate an initial SSID and an initial key, and utilizes the initial SSID and the initial key to perform an authentication procedure with the AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a WLAN system and a method utilized therein according to one embodiment of the present invention.

### DETAILED DESCRIPTION

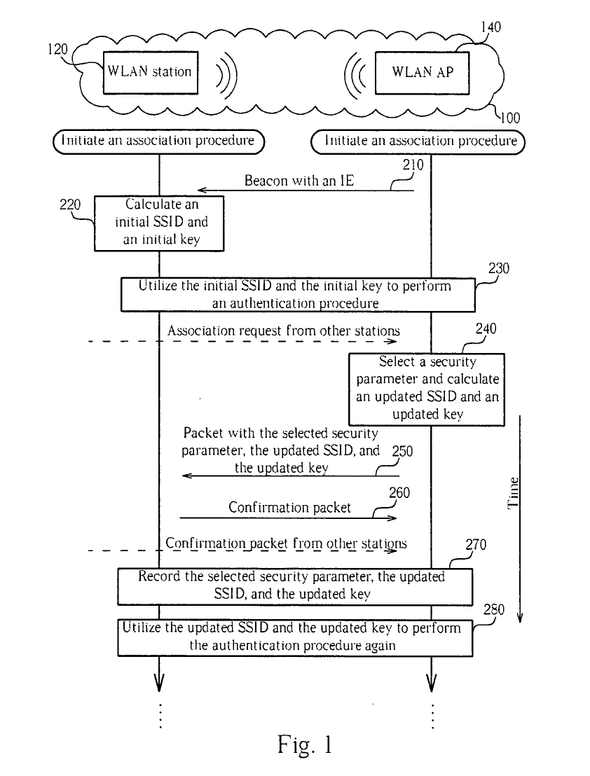

FIG. 1 is a schematic diagram illustrating a wireless local area network (WLAN) system 100 and a method utilized therein according to one embodiment of the present invention. In this embodiment, the WLAN system 100 comprises a WLAN station 120 and a WLAN access point (AP) 140. The WLAN station 120 can be a personal computer, a notebook computer, a WLAN phone, or any other electronic device capable of connecting to the WLAN. The WLAN system 100 can also comprise other WLAN stations and/or other WLAN APs besides the WLAN station 120 and the WLAN AP 140. Since interaction between the WLAN AP 140 and any possible WLAN station is substantially the same, only the interaction between the WLAN AP 140 and the WLAN station 120 is drawn in FIG. 1 as an example.

To improve network security, the WLAN system 100 in this embodiment utilizes a concept called “hidden service set identifier (SSID)”. Additionally, the WLAN system 100 in this embodiment utilizes a method having the following features:
1. A user of the WLAN station 120 needs to neither know nor input an SSID of the WLAN AP 140.
2. The SSID of the WLAN AP 140 is not transmitted plainly. Thus, the SSID of the WLAN AP 140 cannot be easily acquired even when unknown people having ulterior motives intercept WLAN packets transmitted between the WLAN station 120 and the WLAN AP 140. In other words, the WLAN system 100 has a strong and sufficient security level.
3. The user can be absent during the process when the WLAN station 120 and the WLAN AP 140 build WLAN association. In other words, the user is not required to press any specific button at a specific time, notice whether a specific indication light flashes, or input any burdensome password during the association process. Thus, the method provided in this embodiment is highly convenient to the user.

To perform the method in this embodiment successfully, the WLAN station 120 and the WLAN AP 140 must utilize an agreed one-way hash function. The one-way hash function can be built in a network card of the WLAN station 120 and/or the WLAN AP 140 before those devices leave the factory or be set into the WLAN station 120 and/or the WLAN AP 140 by the user himself in advance. Additionally, for network security, the one-way hash function must be protected from those unauthorized.

First, the user initiates association procedures for the WLAN station 120 and the WLAN AP 140 before the method in this embodiment is performed. Before a WLAN setting process is completed, for example, the action that the user turns on power supplies of the WLAN station 120 and the WLAN AP 140 actually means the user wants to initiate an association procedure between the WLAN station 120 and the WLAN AP 140. The steps 210-270 in FIG. 1 are related to a first stage of the method in this embodiment, and the step 280 is related to a second stage thereof.

In the step 210, the WLAN AP 140 broadcasts a beacon with a specific information element (IE) for the WLAN station 120 to obtain an initial SSID and an initial key utilized by the WLAN AP 140 in the first stage. The IE contains at least a field A and a field B. The WLAN station 120 can recognize the WLAN AP 140 as an accessible AP by information contained in the field A. In the step 220, the WLAN station 120 then applies an input value X in the field B into an agreed one-way hash function to calculate the initial SSID and the initial key utilized by the WLAN AP 140 in the first stage. Since the initial SSID and the initial key are calculated from the one-way hash function, it is very difficult to acquire the initial SSID and the initial key for those unauthorized to access the one-way hash function.

Next, in the step 230, the WLAN station 120 and the WLAN AP 140 utilize the initial SSID and the initial key to perform an authentication procedure. The authentication procedure can be, for example, a station authentication procedure. Additionally, the step 230 comprises the following six sub-steps: the WLAN station 120 sends a probe request to the WLAN AP 140 (first sub-step 230_{—}a); the WLAN AP 140 sends a probe response to the WLAN station 120 (second sub-step 230_{—}b); the WLAN station 120 sends an authentication request to the WLAN AP 140 (third sub-step 230_{—}c); the WLAN AP 140 sends an authentication response to the WLAN station 120 (fourth sub-step 230_{—}d); the WLAN station 120 sends an association request to the WLAN AP 140 (fifth sub-step 230_{—}e); and the WLAN AP 140 sends an association response to the WLAN station 120 (sixth sub-step 230_{—}f). The above six sub-steps are not drawn in FIG. 1 for simplicity. Additionally, the WLAN AP 140 only responds to probe requests sent from WLAN stations that calculate the corresponding initial SSIDs correctly. Contrarily, the WLAN AP 140 is not required to respond to probe requests sent from WLAN stations that cannot calculate the corresponding initial SSIDs correctly.

The WLAN station 120 can record its security capability (SEC_CAP) in an IE contained in the association request sent by itself in the fifth sub-step 230_{—}e. The WLAN station 120 can also notifies the WLAN AP 140 of its security capability (SEC_CAP) through other packets. After acquiring security capabilities (SEC_CAPs) of all WLAN stations that request association, the WLAN AP 140 can select a security parameter acceptable for all of the WLAN stations in the step 240 as the security parameter to be utilized in the second stage. Additionally, the step 240 can be before or after the sub-step 230_{—}f. Moreover, in the step 240, the WLAN AP 140 determines an updated SSID and an updated key to be utilized in the second stage. In other embodiments, the step 240 of determining the security parameter, the updated SSID, and the updated key can also be performed by two separate steps together.

There are several methods for the WLAN AP 140 to determine the updated SSID and the updated key. For example, each WLAN station can notify the WLAN AP 140 of a nonce value through the association request or other packets sent to the WLAN AP 140. The WLAN AP 140 can then utilize the first received nonce value and a media access control (MAC) address of the WLAN station that sends the first received nonce value to calculate the updated SSID and the updated key. In another example, the WLAN AP 140 can also determine the updated SSID and the updated key by itself, and thus no WLAN station is required to provide the WLAN AP 140 with any nonce value.

In the step 250, the WLAN AP 140 utilizes a WLAN packet to notify the WLAN station 120 of the selected security parameter, the updated SSID, and the updated key. Additionally, in this step, the WLAN AP 140 utilizes the initial key to encrypt the packet to be broadcasted. The WLAN station 120 then utilizes the initial key to decrypt a received packet. In such way, the updated SSID and the updated key cannot be easily acquired without knowledge of the initial key even when those unauthorized intercept packets sent by the WLAN AP 140 in the step 250.

In a case that the WLAN AP 140 applies the above nonce value (i.e. the first received nonce value) and the MAC address in the one-way hash function to calculate the updated SSID and the updated key, the WLAN AP 140 only needs to notify each WLAN station of the above nonce value and the MAC address in the step 250. The WLAN stations then apply the nonce value and the MAC address selected by the WLAN AP 140 in the one-way hash function by themselves to calculate the updated SSID and the updated key, thereby further improving security of the WLAN system 100.

In the step 260, the WLAN station 120 sends a confirmation packet to the WLAN AP 140. The confirmation packet confirms that the WLAN station 120 and the WLAN AP 140 have agreed on the security parameter selected by the WLAN AP 140. So far, negotiation between the WLAN station 120 and the WLAN AP 140 regarding the security parameter, the updated SSID, and the updated key is ended. The WLAN station 120 and the WLAN AP 140 can then record the selected security parameter, the updated SSID, and the updated key in the step 270.

Follows is the description of the second stage. In this stage, the WLAN AP 140 broadcasts a beacon with no specific IE, thereby enhancing network security. In the step 280, the WLAN station 120 and the WLAN AP 140 utilize the selected security parameter, the updated SSID, and the updated key after negotiation to perform the authentication procedure again. The step 280 and the step 230 are substantially the same except that the SSIDs and the keys utilized therein are different. To assure that the WLAN station 120 and the WLAN AP 140 can execute the step 280 synchronously or nearly synchronously, the WLAN AP 140 broadcasts a disassociation packet between the step 270 and the step 280 to forcibly interrupt association between the WLAN AP 140 and each WLAN station. In another example, the WLAN station 120 and the WLAN AP 140 can reboot after the step 270 to assure that they both execute the step 280 synchronously or nearly synchronously. After the step 280, application programs in the WLAN station 120 can utilize network resources provided by the WLAN system 100.

Please note that once the WLAN station 120 and the WLAN AP 140 negotiate a security parameter, an updated SSID, and an updated key in the steps shown in FIG. 1, it is not required to perform negotiation anymore. Specifically, the WLAN station 120 can store the security parameter, the updated SSID, and the updated key after negotiation into a non-volatile memory. Therefore, the WLAN station 120 can directly utilize the security parameter, the updated SSID, and the updated key stored in the non-volatile memory to build association with the WLAN AP 140 each time when the WLAN station 120 needs to access the WLAN.

When the user wants to add a new WLAN station or a new WLAN AP into the WLAN system 100, or when the user wants to change any one of the security parameter, the updated SSID, or the updated key, the user can reboot all devices (including the WLAN station 120, the WLAN AP 140, and other WLAN devices not drawn) in the WLAN system 100. In such a case, devices in the WLAN system 100 can negotiate a new security parameter, a new updated SSID, and a new updated key and thus utilize the new security parameter, the new updated SSID, and the new updated key after negotiation to perform WLAN association.

Additionally, the WLAN AP 140 can utilize a timer to perform the steps 210-230_f within a certain time limit (e.g. X minutes) and/or perform the steps 250-270 within another time limit (e.g. Y minutes), thereby protecting the WLAN system 100 from malevolent attacks by hackers utilizing a dictionary attack method or any other network attack method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method utilized in a wireless local area network (WLAN) system, wherein the WLAN system comprises a station and an access point (AP), the method comprising steps of:
transmitting an input value to the station by the AP;
utilizing the input value to calculate an initial service set identifier (SSID) and an initial key by the station; and
utilizing the initial SSID and the initial key to perform an authentication procedure by the station and the AP.

2. The method of claim 1, wherein the step of transmitting the input value to the station by the AP comprises steps of:
broadcasting a beacon with the input value by the AP; and
receiving the beacon to get the input value out thereof by the station.

3. The method of claim 1, wherein the step of utilizing the input value to calculate the initial SSID and the initial key by the station comprises a step of:
applying the input value in a one-way hash function to calculate the initial SSID and the initial key by the station.

4. The method of claim 1, further comprising steps of:
calculating an updated SSID and an updated key by the AP;
notifying the station of the updated SSID and the updated key by the AP; and
utilizing the updated SSID and the updated key to perform the authentication procedure again by the station and the AP.

5. The method of claim 4, wherein the step of notifying the station of the updated SSID and the updated key by the AP comprises steps of:
sending out at least a packet with the updated SSID and the updated key by the AP; and
receiving the packet to get the updated SSID and the updated key out thereof by the station.

6. The method of claim 4, wherein the step of calculating the updated SSID and the updated key by the AP comprises a step of:
applying a nonce value and a media access control (MAC) address in a one-way hash function to calculate the updated SSID and the updated key by the AP.

7. The method of claim 1, further comprising a step of:
sending out a disassociation packet to interrupt association between the AP and the station by the AP after the AP notifies the station of the updated SSID and the updated key.

8. A WLAN system, comprising:
an AP, for providing an input value; and
a station, for receiving the input value provided from the AP and utilizing the input value to calculate an initial SSID and an initial key;
wherein the station and the AP utilize the initial SSID and the initial key to perform an authentication procedure.

9. The system of claim 8, wherein the AP broadcasts a beacon with the input value for providing the station with the input value.

10. The system of claim 8, wherein the station applies the input value in a one-way hash function to calculate the initial SSID and the initial key.

11. The system of claim 8, wherein the AP calculates an updated SSID and an updated key, the AP notifies the station of the updated SSID and the updated key, and the station and the AP utilizes the updated SSID and the updated key to perform the authentication procedure again.

12. The system of claim 11, wherein the AP sends out at least a packet with the updated SSID and the updated key for notifying the station of the updated SSID and the updated key.

13. The system of claim 11, wherein the AP applies a nonce value and a MAC address in a one-way hash function to calculate the updated SSID and the updated key.

14. The system of claim 13, wherein the AP notifies the station of the nonce value and the MAC address, and the station applies the nonce value and the MAC address in the one-way hash function to calculate the updated SSID and the updated key.

15. The system of claim 8, wherein the AP sends out a disassociation packet to interrupt association between the AP and the station after the station and the AP utilize the initial SSID and the initial key to perform the authentication procedure.

16. An access point (AP) disposed in a WLAN system, wherein the WLAN system further comprises a station, the AP provides the station with an input value and utilizes an initial SSID and an initial key to perform an authentication procedure with the station, and the input value is utilized to calculate the initial SSID and the initial key.

17. The AP of claim 16, wherein the AP broadcasts a beacon with the input value for providing the station with the input value.

18. The AP of claim 16, wherein the AP calculates an updated SSID and an updated key, notifies the station of the updated SSID and the updated key, and utilizes the updated SSID and the updated key to perform the authentication procedure with the station again.

19. The AP of claim 18, wherein the AP applies a nonce value and a MAC address in a one-way hash function to calculate the updated SSID and the updated key.

20. The AP of claim 19, wherein the AP notifies the station of the nonce value and the MAC address, and the station applies the nonce value and the MAC address in the one-way hash function to calculate the updated SSID and the updated key.

21. The AP of claim 16, wherein the AP sends out a disassociation packet to interrupt association between the AP and the station after the AP utilizes the initial SSID and the initial key to perform the authentication procedure with the station.

22. A station disposed in a WLAN system, wherein the WLAN system further comprises an AP, and the station receives an input value provided from the AP, utilizes the input value to calculate an initial SSID and an initial key, and utilizes the initial SSID and the initial key to perform an authentication procedure with the AP.

23. The station of claim 22, wherein the station applies the input value in a one-way hash function to calculate the initial SSID and the initial key.

24. The station of claim 22, wherein the station receives at least a packet with an updated SSID and an updated key from the AP and utilizes the updated SSID and the updated key to perform the authentication procedure with the AP.

25. The station of claim 24, wherein the station utilizes the initial key to decrypt the packet.
